(19) United States
(12) Patent Application Publication
(10) Pub. No.: US 2022/0172265 A1
(43) Pub. Date: Jun. 2, 2022

(54) COLLABORATION PLATFORM

(71) Applicant: Verified Supply Inc., North York (CA)

(72) Inventor: BRENT MACKINNON, MISSISSAUGA (CA)

(21) Appl. No.: 17/105,799

(22) Filed: Nov. 27, 2020

(51) Int. Cl. G06Q 30/06; G06F 9/451; G06F 16/903

(52) U.S. Cl. CPC G06Q 30/0611; G06F 16/90335; G06Q 30/0641; G06F 9/453

(57) ABSTRACT

A business-to-business (B2B) system has a collaboration host and client devices connectible to the host. A client device identifies to the host an authorized set of client devices and a product category. The host library stores approved web base domains, links to pages in those domains, and product attributes for products featured in the web pages. The host search module enables client device access to a search engine but limits search results to web pages from the approved web base domains. Upon selection, the collaboration host delivers to the client devices the selected page and attribute data associated with that page. The client devices are used to generate a collaborative overlay view containing annotations related to the selected page. When the selected page is subsequently accessed through the search module, the host delivers the current overlay view combined with the selected page as a current project view.

### FIELD OF THE INVENTION

The present invention relates generally to a collaboration method and platform particularly but not exclusively suitable for collaboration by a buying group to facilitate and hasten development of a request for proposal (RFP) for issuing to a supplier.

### BACKGROUND

Obtaining quotations for products, whether for goods or services and whether for wholesale or retail, can be a time-consuming and frustrating affair, especially if there are many stakeholders who will be affected by the nature of the chosen supplier and supplied product and/or who may have unique information and perspective that could influence that choice.

In the past a manual operation for generating competitive quotations had an intending buyer preparing an RFP (also referred to as request for quotation or request for pricing) and mailing it to prospective vendors who would after a period of time respond with a price quotation. With the advent of the internet and the World Wide Web, an intending buyer will usually perform web searches using a preferred search engine. For example, if seeking a quote for a heavy-duty vacuum pump for pumping water or aqueous solutions, the intending buyer might access an advanced search capability such as Advanced Google Search and then enter a combination of such search terms as “pump”, “vacuum”, “heavy duty” and “water”. This will throw up a host of results. Most of these will be websites for particular manufacturers, but there may also be sites where pump data from several manufacturers is aggregated. The intending buyer will then review the pump details from a particular manufacturer(s), often doing this by laboriously stepping through pages of a manufacturer's online catalog. The intending buyer will then identify pumps that are closest to possessing attributes which the buyer is seeking. For example, a pump may have a particular footprint, a particular maximum flow capacity, a particular output pressure, compatibility with other subsystems and components, be of heavy (or light) duty materials and components, and have a particular electrical system rating, etc. It may be equally important for the intending buyer to exclude pumps having a particular attribute which the buyer does not want. To obtain a comparative review, the buyer will search through product offerings of a number of manufacturers.

For an intending buyer having a particular requirement, then for each promising manufacturer or vendor, the buyer might contact a sales representative at the manufacturer or vendor to present the intending buyer's particular needs and to request a price quotation. The buyer requirement may be a single product or service or may be more complicated, such as a multi-product system. There will typically be some period of time before the prospective vendor is able to return to the buyer with a description of the nature of the product (or service) that the vendor can furnish and the proposed price. To avoid unnecessary delay, the buyer may contemporaneously request quotations from a number of manufacturers. Typically, quotations will come back from the prospective vendors at various times and there will inevitably be variation in what can be supplied by the different vendors. While some may offer exactly what the buyer seeks, others may offer a variation where a particular attribute is not available or where additional attributes not hitherto called for by the buyer are part of the offered product. Subsequently, the buyer will typically have discussions with each of the quoting vendors in order to get a full picture of each product offering and its price and in order to enable a competitive review to be performed. The whole process from beginning a search to inking a sales contract may take up to several months especially for complex and expensive systems.

It would be valuable to reduce the time and complexity of typical procedures for generating competitive quotations.

Co-pending U.S. patent application Ser. No. 16/658,042 (System and method for generating competitive requests for quotations) filed Oct. 19, 2019, describes a method for use in generating competitive quotations for business-to-business purchasing. The disclosure of U.S. Ser. No. 16/658,042 is hereby incorporated by reference in its entirety for all purposes. In operation, a client inputs a product category to an RFP server and a list of possible attributes for the products of that category are provided to the client. The client selects from the attributes and the RFP server generates and delivers to the client data for products having those attributes. The client identifies the desired product from the product data and requests an RFP. At the server, vendors of that product are identified and a rules-based selection from the vendors is made. RFPs are issued from the server to the selected vendors and, when quotations are received, are directed to the client. While the subject invention of U.S. Ser. No. 16/658,042 can considerably speed up the preparation of RFPs, further reduction of RFP preparation time, especially for business-to-business (B2B) transactions, is desirable.

A B2B buying exercise typically includes the following steps:
establishing the nature of the market issue/opportunity for the customer organization;
identifying and examining possible solutions;
establishing product need(s) for a selected solution(s);
identifying a suitable product(s) and supplier(s);
investigating in detail each product and supplier to verify they are truly satisfactory; and
obtaining agreement from the organization's stakeholders and experts as a prelude to issuing an RFP to a preferred supplier(s) for that product.

These steps, and the associated tasks required to complete each step, may require the participation and collaboration of several people who can be viewed as members of a buying team. In some cases, a person may be able to perform their task or tasks only after another task has been completed by another participant. In other cases, a person may be able to perform their task or tasks independently and at any time, without waiting for input from another person. Subject to the imposition of a need-to-know sharing status for certain sensitive information, it is desirable that information from performing each of the tasks is made promptly available to any other participant who may need the information or benefit from it. Moreover, it may sometimes be of value to have joint discussion among all or a subset of the buying team regarding a particular piece of information or a possible business direction arising from consideration of it.

### SUMMARY OF THE INVENTION

According to one aspect of the invention, there is provided a business-to-business (B2B) system comprising a collaboration host, and a plurality of client devices connectible to the collaboration host, each client device configured to enable identification to the collaboration host of members of a buying group respectively accessing an authorized set of the client devices, and a product category from said pre-assigned product category designations, the collaboration host having: a memory module storing a library of (a) web base domains, (b) pre-assigned product category designations for product web pages in said base domains, and (c) a list of pre-assigned attribute designations for products that are the respective subjects of the product pages; a search module having a first interface providing search access between the search module and a search engine, and a second interface providing search access between the search module and any of the authorized set of client devices, the search module programmed in response to inputting of the product category to restrict search results obtained from the search engine to page links for the product web pages; a selection module configured to enable selection by one of the authorized set of client devices of a page link from the restricted search results, the collaboration host, in response, presenting to the authorized set of client devices (a) the selected product page and (b) the list of pre-assigned attributes for the product page; an annotation module configured to enable a client of the group to generate an overlay view containing annotations related to the selected page and to enable any client of the group to further annotate the overlay view, and a combination module configured to load the overlay view in response to the selected page being accessed and to display the overlay view and the selected page as a combined project view.

The annotation module can be configured to add annotations to the overlay view which are any of a highlight, text, an image, a video, a question, a comment and a web link. Preferably, the annotation module is configured to recognize and categorize annotations, to display the categories as category icons at dashboards of the authorized set of client devices separately from the combined project view, and to make individual categorized annotations accessible at the category icons. The annotation module can be configured to trigger access to an annotation on the combined project view when the category icon for that annotation is accessed.

The system can further comprise a communication module configured to enable communication between the authorized set of client devices. The communication module can afford a real time communication channel between members of the buying group.

The client devices can be configured to permit inputting of an unassigned attribute descriptor, the collaboration host configured to receive the unassigned attribute descriptor and to add it to the list of pre-assigned attribute designations for said products that are the subject of said product pages.

The system can further comprise an RFP request module configured to receive a request for an RFP from one of the client devices and to present to the requesting client device an RFP wizard for completion.

According to another aspect of the invention, there is provided a business-to-business method for use by a collaboration host, and a plurality of client devices connectible to the collaboration host, comprising identifying to the collaboration host from one of the client devices members of a buying group respectively accessing an authorized set of the client devices, identifying to the collaboration host a product category from a library at the collaboration host storing a list of web base domains and pre-assigned product category designations for product web pages in said web base domains, in response to the identifying the product category, initiating a web search on a search engine and by means of a search module at the collaboration host restricting search results obtained from the search engine to page links corresponding to pages from said product web pages, from one of the authorized set of client devices, selecting a product web page link from the search results, and, from the collaboration host, presenting in response to the authorized set of client devices (a) the selected product page and (b) the pre-assigned attributes for the selected product page, at the collaboration host, generating an overlay view containing annotations related to the selected product page, combining the overlay view with the selected product web page to create a current combined project view page, serving the current combined project view page to the client devices of the authorized set thereof, and enabling any of the authorized set of client devices to further annotate the overlay view.

According to a further aspect of the invention, there is provided a collaboration platform for use by authorized members of a group, the group members respectively accessing an authorized set of client devices, the collaboration platform comprising a memory module storing a library of (a) a list of approved web base domains, (b) a list of pre-assigned category designations for web pages in said base domains, (c) page links for the web pages in said base domains, and (c) pre-assigned attribute designations for items that are the respective subjects of the web pages in said base domains, a search module having a first interface providing search access between the search module and a search engine, and a second interface providing search access between the search module and any of the authorized set of client devices, the search module programmed in response to inputting of a category designation to restrict search results obtained from the search engine to page links for the web pages in said base domains, a selection module configured to enable selection by one of the authorized set of client devices of a page link from the restricted search results, the collaboration host, in response, presenting to the authorized set of client devices (a) the selected web page and (b) the list of pre-assigned attributes for the selected web page, an annotation module configured to enable a client of the group to generate an overlay view containing annotations related to the selected page and to enable any client of the group to further annotate the overlay view, and a combination module configured to load the overlay view in response to the selected page being accessed and to display the overlay view and the selected page as a combined project view.

### BRIEF DESCRIPTION OF THE DRAWINGS

FIG. 1 is block diagram view of a system according to one embodiment of the invention.

FIG. 2 shows a schematic view of steps in the operation of the system of FIG. 1.

FIG. 3 shows a schematic view of a search module forming part of a collaboration host according to an embodiment of the invention.

FIG. 4 shows a schematic view of a search module forming part of a collaboration host according to an embodiment of the invention.

FIG. 5 shows a schematic view of a communication module forming part of a collaboration host according to an embodiment of the invention.

### DETAILED DESCRIPTION OF THE INVENTION INCLUDING THE PRESENTLY PREFERRED EMBODIMENTS

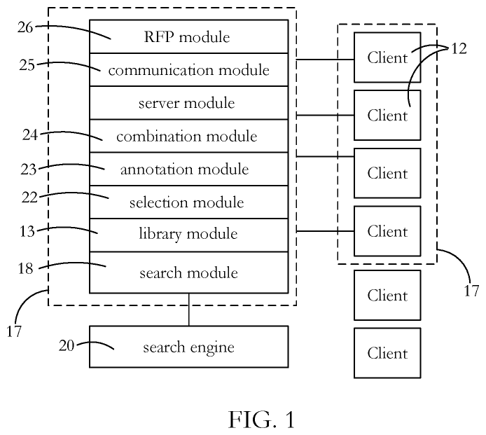

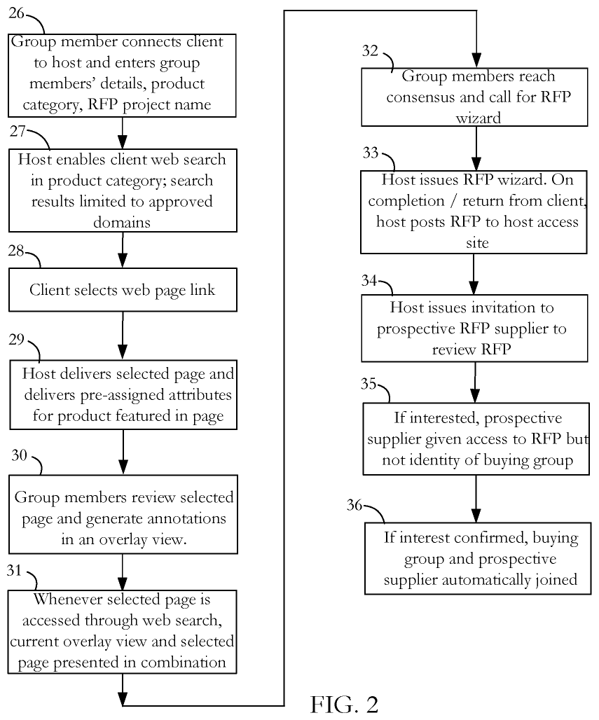

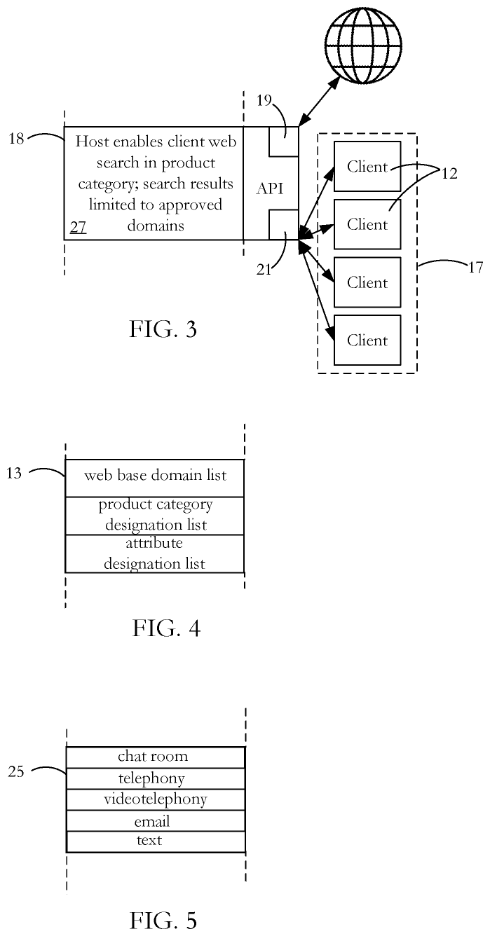

Referring in detail to FIG. 1, there is illustrated a business-to-business (B2B) system 10 comprising an RFP collaboration host 11 and a plurality of client devices 12. The RFP collaboration host has a library module 13 which, as shown in FIG. 4, stores lists of (a) web base domains 14, (b) pre-assigned product category designations 15 for product web pages in the base domains 14, and (c) pre-assigned attribute designations 16 for each of the products that are the respective subjects of the product pages.

Each client device 12 is configured to enable identification to the host of (a) members of an authorized buying group 17, each member of the group having access to the host through a respective one of the client devices 12, (b) a product category selected from the pre-assigned product category designations 15, and (c) an assigned project name.

Also included in the RFP collaboration host functionality is a search module 18. The search module has an interface 19 providing search access between the search module and a search engine 20 and a second interface 21 providing search access for the purposes of pursuing the project from any of the buying group client devices 12 to the search module 18. The search module 18 is programmed in response to inputting of the product category to restrict search results obtained from the search engine 20 to page links for product web pages only within base domains from the list of base domains stored in the library module 13.

Also included in the RFP collaboration host functionality is a selection module 22. The selection module is configured to enable selection by any of the client devices of a page link from the restricted search results. In response to the selection being made, the selection module 22 operates to present to the buying group client devices (a) the product page corresponding to the selected page link and (b) the pre-assigned attributes for the product featured on that page.

The exploration of a product or service featured in a selected product page typically warrants the participation and collaboration of several people and the RFP collaboration host 11 offers tools for use by members of the buying group in relation to, and for the purposes of, pursuing the project.

One of the tools included in the RFP collaboration host functionality is an annotation module 23 configured to enable any member of the buying group to generate an initial overlay view containing annotations related to the selected product page. The initial overlay view is stored at the collaboration host. Any member of the buying group can further annotate the initial overlay view by issuing commands from the client device dashboard, the commands being processed by the annotation module. The initial view as supplemented by further annotations is stored at the host as a current project overlay view for access by any of the client devices used by members of the buying group.

Also included in the RFP collaboration host functionality is a combination module 24 configured to load and display the current project overlay view in combination with the selected page. This project view page is generated and displayed at a client device in response to any subsequent search for the selected page made by one of the group client devices through the RFP collaboration host.

Also included in the RFP collaboration host functionality is a communication module 25 configured to enable parallel communication between members of the buying group.

Also included in the RFP collaboration host functionality is an RFP module 26 configured to receive a request from one of the group client devices to generate and issue a form RFP for the product or service of a selected page. In an alternative embodiment, the RFP collaboration host is configured to respond to a request for competitive RFPs by (a) determining from the web page library if there are multiple vendors of the selected product, (b) generating a rules-based selection and/or ranking of the multiple vendors, and (c) presenting to the buying group client a quotation for the identified product from at least one of the multiple vendors.

An RFP method according to an embodiment of the invention can be implemented for products, including materials and systems (including hardware and software), for services (such as installation or repair), and for combinations of products and services.

In operation of the RFP system, as a first step 27, details of the members of the particular buying group and the name selected for the project are entered at one of the client devices and are communicated to the RFP collaboration host. The buying group typically comprises stakeholders and information holders who have investment or other interest in the nature of the product and the supplier which will eventually be chosen to be the subject of an RFP.

Members can be subsequently added to, or dropped from, a buying group, usually by the creator or appointed leader of the buying group. For easy identification and first level security at the RFP collaboration host, the buying group members are assigned a common domain name which is indicated in their email addresses to show for sign-in purposes that they are members of that buying group. Different members of the buying group may have any of different access, viewing and annotating privileges.

The buying group members working through their associated client device may at any time be working alone on the collaboration platform 10 in terms of performing any function contributing to the end-point of generating and issuing an RFP. Alternatively, two or more members can be working together, either consecutively or concurrently.

All buying group annotation taking place on the collaboration platform 10 is aggregated automatically to the project view page. The ability for the buying group members to act together or individually with knowledge of what others have done and are doing reduces the chance of unnecessary work duplication and can significantly reduce the time for completion of the project and issue of an RFP.

Referring to the flow chart of FIG. 1, a sequence of steps for the RFP method is initiated at step 27 upon a member of the buying group establishing a connection between that member's client device and the RFP collaboration host. The client device can, for example, be any of a smart phone, laptop computer, desktop computer, or similar device capable of data input and having display and/or audio output for presenting data, menus, prompts, etc., to the client devices associated with other members of the buying group. Connection between a client device and the RFP collaboration host can, for example, be a dedicated line or internet connection with a link being for example any of dial-up, digital subscriber line, cable/modem, wireless, such as Wi-Fi, satellite and cellular.

A server module in the RFP collaboration host presents a menu to the buying group member's client device to enable the member to enter and receive data and commands necessary to move through the steps of the RFP collaboration method. The initiating member enters the identities and other details of all of the other buying group members including common domain email addresses for subsequent communication between members of the buying group and the system host. They also enter a project name such as 2020 Company Pump Project and a product category such as ‘vacuum pump’. While this data is preferably all entered at the same time to initiate the collaborative procedure, elements of the data can be entered later provided sufficient of the data is entered for system requirements to be met and for the procedure to begin.

In response to the product category being entered, the RFP collaboration host, at step 28, allows access from any of the buying group client devices 12 through the search module 18 which has an application programming interface with the search engine 20. The search engine can, for example, be any of a general search engine, a general B2B search engine, a market niche-oriented or other search engine. The search module 18 limits results served from the search engine 20 through the RFP collaboration host 10 to page links of base domains of previously approved suppliers which have been registered for access to the B2B system. An algorithm determines the listing order of the page links and may otherwise manipulate the presentation of search results according to rules programmed into the search module. In one implementation, the order of URL links presented in the search results corresponds to ranking hierarchy positions previously bought by buyers registered for participation on the collaboration platform.

At step 28, the buying group member selects a desired web page link from the restricted search results and, in response, step 29, the product page is presented at the buying group member's client device, with the transaction still being conducted through the search module 18. At the time of serving the product page, the RFP collaboration host 10 obtains attribute data previously generated for the product featured on that product page and stored in the collaboration host library module 13. The attribute data is also presented to the buying group member client device for simultaneous display on the client device dashboard. The attribute data is assigned to and shown in one or more categories. Attribute categories common to all products may include, for example, product name, single product price, product condition, stock keeping unit (SKU) and stock quantity. Other attribute categories may be tailored to the product category. Tailored or optional attribute information might include, for example, for the vacuum pumps product category previously mentioned, operating voltage, horse power, manufacturer, noise level, vendor special or tier pricing, etc. The client device dashboards may also allow entry by any of the project buying group members of elected attributes, where such attributes are considered important to the buying group member but which do not exist in the general attribute list previously assigned to the product.

In an alternative embodiment of the invention, a buying group member may use compilation tools available at the RFP collaboration host 10 to develop a more focused view of interest before the search is conducted. Thus, in response to the identification at a client device of a product category, the RFP collaboration host responds by issuing to the client device a list of possible attributes for the product category. A selection from the list of possible attributes is then made at the client device. The selection may, for example, be a single selection from the original attribute list or may be a two-phase process in which, in response to client device selection of primary attributes, the RFP collaboration host compiles and sends to the client device a list of subsidiary or optional attributes. The intending buyer then makes a more refined attribute selection.

In a further embodiment of the invention, the buying group member has the option of listing the desired attributes in descending order of importance. In another embodiment, the intending buyer has the option of indicating attributes that are specifically not required. Each of these refinements can be input to the search module 18 with the object of focusing the ensuing search. The end point of collaboration on the project is the development of an RFP for an identified, favoured product and supplier and so any elected attribute will eventually be included in the RFP viewed by that supplier.

Members of the buying group may, individually or following consultation with other members of the group, identify and access one or more product pages, all being prospective candidates for development of an RFP.

Referring to step 30, to initiate a collaborative exploration of a selected product page, a member of the buying group accesses a selected product page and uses tools in the annotation module 23 to generate an initial overlay view for combining with the selected product page. An exemplary form of annotation technology is the open source Hypothesis application, the description of which at https://web.hypothesis/help/overview-of-the-hypothesis-system/, including any subsidiary or related pages in its hierarchy, is hereby incorporated by reference in its entirety. Examples of possible annotations available using the Hypothesis application are highlights, text, images, videos, questions, comments, web links, etc. Any buying group member, alone or in cooperation with other group members, provided they have an appropriate edit privilege, can add to the overlay which is constantly autosaved to ensure a current view. As shown at step 31, combination module 24 is programmed to load and display the current overlay view combined with the selected product page whenever the selected product page is subsequently accessed through the search module 18 by a group member.

At the time that a buying group member adds an annotation to a web page, the annotation module 23 adds an identifier that an annotation has been generated for that page. The annotation application remembers where the annotation appears on a particular page of the search results and serves the annotation on the page where it was added by the buying group member every time that the page is subsequently loaded for access by a member of the buying group. As well as being available in integrated form with the selected product page to show a combined view, all generated annotations are automatically assigned to categories such as questions, videos, comments, etc., with category icons displayed on client device dashboards. In this way, any buying member logging into the selected product page can go quickly to a category to see, for example, what questions have been posed or are outstanding in relation to that product page. In one embodiment, a categorized annotation viewed at a category icon has a hot link enabling the viewer to view that annotation at the appropriate position on the current combined view. In other embodiments, the category view provides a chronological record of entries or identities of annotators.

As previously indicated, the collaboration platform also includes a communication module 25 enabling communication between the buying group members. This may be one or more real-time applications such as telephony, videotelephony or on-line chat. In this way, members are able to view, discuss and develop the current project view page together. Emails and like delay-characterized communications are tagged as communications between buying group members for the purposes of the project and may also be routed between buying members or directed to an inbox on a subset of, or all, client device dashboards. The communication module may have an API enabling interoperation with commercially available communication services or the communication module may, in relation to one or more communication methods, be self-contained.

The buying group objective may be an RFP for either a single product or service or a multi-product system, a multi-service undertaking or a product(s)/service(s) combination. The buying group in its exploration and consideration of candidate products/services and suppliers may review and annotate many potential product pages. Eventually, following consultation and review facilitated by the collaboration platform, the buying group reaches a consensus, step 32, on a favoured product and supplier and it is time then to develop and issue an RFP.

Following an RFP ready condition being entered at one of the buying group client devices, the host responds at step 33 by providing a wizard to the client device for completion by the buying group member. The completed wizard, identifying the product/service and supplier, is sent back to the host by the buying group member. In response, a completed RFP is made available at the RFP host for access by the identified supplier provided that the supplier has previously been registered as eligible for participation in an RFP process to be conducted through the host. At step 34, the selected supplier receives a communication, such as an email, from the host, notifying them that there is an RFP from an intending buyer available for review at the RFP host. At step 35, if the targeted supplier logs into the RFP system, they can view the RFP in its entirety except that they cannot see from whom the RFP originates; i.e., the buying group and affiliation remain anonymous at that time. The RFP host offers the prospective supplier the option of either accepting or declining the invitation to respond to the RFP. If the supplier accepts at step 36, the RFP host furnishes the intending buyer details to the prospective supplier and the prospective supplier is charged an acceptance fee which is paid to collaboration platform operator. From this point, the prospective supplier develops and issues a proposal/quotation, whereupon the parties enter into direct discussion leading eventually to a contact arrangement or disengagement.

The buying group typically includes employees of a company contemplating the development and issuing of an RFP, but may also include outside guests such as experts or even prospective and past suppliers. Guests normally have limited privilege and access; for example, being limited solely to a communications link such as a chat room. Use of a collaborative platform according to the invention is typically free for any buyer accessing the system and providing their identity details. This recognizes that buyers use the platform because it makes the job of developing and issuing RFPs much easier and quicker than has been the case in the past. Because buyers use the collaborative platform in developing RFPs, suppliers find the platform attractive in that it is a source of business-potential RFPs which are valuable sales leads. As well as the supplier charging sources disclosed elsewhere in this specification, suppliers pay a periodic subscription fee to the collaboration platform operator for the opportunity of using the platform. It will be understood that in real terms, especially in B2B transactions, buyers are also invariably sellers (suppliers) in other circumstances and so their financial support of the platform for selling purposes also brings the benefit of using the platform in a buying role.

The RFP collaboration system and method are described in the context of identifying a single source—product/supplier—to which to issue an RFP. In an alternative embodiment, the collaboration method can be used to solicit a competitive RFP bid from different suppliers for the same or similar product.

In this specification, the terms request for proposal (RFP), request for quotation (RFQ) and request for information (RFI) are used interchangeably. It will be understood that these terms are distinguishable from each other but all can benefit from use of the invention. In this specification, the terms ‘vendor’ and ‘supplier’ are used interchangeably. It will be understood that these terms are distinguishable from each other but both can benefit from use of the invention.

Other variations and modifications will be apparent to those skilled in the art and the embodiments of the invention described and illustrated are not intended to be limiting. The principles of the invention contemplate many alternatives having advantages and properties evident in the exemplary embodiments.

What is claimed is:

1. A business-to-business (B2B) system comprising:
a collaboration host, and a plurality of client devices connectible to the collaboration host, each client device configured to enable identification to the collaboration host of
members of a buying group having access to the host through an authorized set of the client devices, and
a product category from a set of pre-assigned product category designations, the collaboration host having:
a memory module storing a library of (a) web base domains, (b) said set of pre-assigned product category designations for product web pages in said base domains, and (c) a list of pre-assigned attribute designations for products that are the respective subjects of the product pages,
a search module having a first interface providing search access between the search module and a search engine, and a second interface providing search access between the search module and any of the authorized set of client devices, the search module programmed in response to inputting of the product category to restrict search results obtained from the search engine to page links for the product web pages,
a selection module configured to enable selection by one of the authorized set of client devices of a page link from the restricted search results, the collaboration host, in response, presenting to the authorized set of client devices (a) the selected product page and (b) the list of pre-assigned attributes for the product page,
an annotation module configured to enable a client of the group to generate an overlay view containing annotations related to the selected page and to enable any client of the group to further annotate the overlay view, and
a combination module configured to load the overlay view in response to the selected page being accessed and to display the overlay view and the selected page as a combined project view.

2. The B2B system claimed in claim 1, wherein the annotation module is configured to add an annotation to the overlay view, which annotation is one of the group consisting of a highlight, text, an image, a video, a question, a comment and a web link.

3. The B2B system claimed in claim 1, wherein the annotation module is configured to recognize and categorize annotations, to display the categories as category icons at dashboards of the authorized set of client devices separately from the combined project view, and to make individual categorized annotations accessible at the category icons.

4. The B2B system claimed in claim 3, wherein the annotation module is configured to trigger access to an annotation on the combined project view when the category icon for that annotation is accessed.

5. The B2B system claimed in claim 1, wherein the collaboration host has a communication module configured to enable communication between the buying group members.

6. The B2B system claimed in claim 5, wherein the communication module affords a real time communication channel between the buying group members.

7. The B2B system claimed in claim 1, the client devices configured to permit inputting of an unassigned attribute descriptor, the collaboration host configured to receive the unassigned attribute descriptor and to add it to the list of pre-assigned attribute designations for said products that are the subject of said product pages.

8. The B2B system claimed in claim 1, wherein the collaboration host has an RFP module configured to receive a request for an RFP wizard from any one of the authorized set of client devices and to present to the requesting client device an RFP wizard for completion.

9. The B2B system claimed in claim 1, further comprising a collaboration host save module to regularly save the overlay view as it is developed.

10. The B2B system claimed in claim 1, further comprising a collaboration host server module configured to serve the combined project view to at least some of the authorized set of client devices.

11. The B2B system claimed in claim 1, wherein the collaboration host, in response to client device selection of the selected page determines vendors of the identified product from the product web page library and identifies the vendors to the client device.

12. The B2B system claimed in claim 11, wherein the collaboration host has a request module configured to generate a rules-based selection from the vendors.

13. The B2B system claimed in claim 11, the request module further configured to present to at least one of the authorized set of client devices a quotation for the identified product from at least one of the vendors.

14. A business-to-business (B2B) method for use by a collaboration host, and a plurality of client devices connectible to the collaboration host, comprising:
identifying to the collaboration host from one of the client devices members of a buying group respectively accessing an authorized set of the client devices, and identifying to the collaboration host a product category from a library at the collaboration host storing a list of web base domains and storing pre-assigned product category designations for product web pages in said web base domains,
in response to the identifying the product category, initiating a web search on a search engine and by means of a search module at the collaboration host restricting search results obtained from the search engine to page links corresponding to pages from said product web pages,
from one of the authorized set of client devices, selecting a product web page link from the search results, and, from the collaboration host, presenting in response to the authorized set of client devices (a) the selected product page and (b) the pre-assigned attributes for the selected product page,
at the collaboration host, generating an overlay view containing annotations related to the selected product page, combining the overlay view with the selected product web page to create a current combined project view page, serving the current combined project view page to the client devices of the authorized set thereof, and enabling any of the authorized set of client devices to further annotate the overlay view.

15. A collaboration platform for use by authorized members of a group having access to a collaboration platform through respective ones of an authorized set of client devices, the collaboration platform comprising:
a memory module storing a library of (a) a list of approved web base domains, (b) a list of pre-assigned category designations for web pages in said base domains, (c) page links for the web pages in said base domains, and (c) pre-assigned attribute designations for items that are the respective subjects of the web pages in said base domains,
a search module having a first interface providing search access between the search module and a search engine, and a second interface providing search access between the search module and any of the authorized set of client devices, the search module programmed in response to inputting of a category designation to restrict search results obtained from the search engine to page links for the web pages in said base domains,
a selection module configured to enable selection by one of the authorized set of client devices of a page link from the restricted search results, the collaboration host, in response, presenting to the authorized set of client devices (a) the selected web page and (b) the list of pre-assigned attributes for the selected web page,
an annotation module configured to enable a client of the group to generate an overlay view containing annotations related to the selected page and to enable any client of the group to further annotate the overlay view, and
a combination module configured to load the overlay view in response to the selected page being accessed and to display the overlay view and the selected page as a combined project view.
